(19) United States
(12) Patent Application Publication
(10) Pub. No.: US 2025/0169510 A1
(43) Pub. Date: May 29, 2025

(54) TOPPING SYSTEM OF PIZZA DISC FOR AUTOMATIC PIZZA PREPARATION MACHINES

(71) Applicant: HOFBURG FOOD TECHNOLOGIES LLC, Lewes, DE (US)

(72) Inventor: Tullio ANGHEBEN, Lewes, DE (US)

(21) Appl. No.: 18/843,499

(22) PCT Filed: Mar. 9, 2023
(86) PCT No.: PCT/IB2023/052245

§ 371 Date: Sep. 3, 2024

(30) Foreign Application Priority Data
Mar. 9, 2022 (IT) 102022000004553

(51) Int. Cl. A21C 9/04; A21C 9/08; G07F 17/00

(52) U.S. Cl. CPC A21C 9/04; A21C 9/083; G07F 17/0064

(57) ABSTRACT

The topping system (22) of pizza discs for automatic pizza preparation machines comprises:—a plurality of dispensing cylinders (23, 24, 25, 26), each containing one ingredient which is usable as a topping for one pizza disc (D) and is deliverable by dropping onto the latter;—positioning means (27) which are arranged inferiorly to the dispensing cylinders (23, 24, 25, 26) and are adapted to position the pizza disc (D) at the point where each of the dispensing cylinders (23, 24, 25, 26) is located, the dispensing cylinders (23, 24, 25, 26) being arranged parallel to each other around one substantially vertical common central axis (A).

### TECHNICAL FIELD

The present invention relates to a topping system of pizza discs for automatic pizza preparation machines.

### BACKGROUND ART

The use of automatic pizza preparation machines is nowadays increasingly popular and appreciated by consumers.

The reason for this is mainly because such machines allow pizzas to be prepared in a short time and substantially at any time of the day, proving to be quite versatile in their use.

These features, therefore, make it possible to cater to the various and numerous needs of consumers who, for example, may have short time to consume their pizza and, therefore, require it to be prepared quickly, and/or may wish to snack after a meal.

Automatic pizza preparation machines can be activated by entering money on the part of a user; once this is done, it is sufficient the latter selects the desired type of pizza for the preparation of the same to start.

For this purpose, the aforementioned machines are typically provided with at least:
a storage area, where one or more pizza discs (i.e., flour dough with a discoidal conformation used as a base for pizzas) pre-packaged in one or more plastic packages are stored at low temperature;
a topping area, where ingredients (e.g., tomato, cheese, vegetables, cold cuts and so on) are stored fresh for use as toppings for pizza discs; and with
a baking area for topped pizza discs.

With particular reference to the topping area, it is well known that topping systems are used aimed at selectively delivering ingredients onto pizza discs and comprising one or more dispensing cylinders.

Specifically, each of the dispensing cylinders contains one of the previously listed ingredients and is automatically activated to release part of its contents onto the pizza disc once the latter is arranged below the same.

In actual facts, depending on the type of pizza selected by the user, the topping system moves the pizza disc under each of the dispensing cylinders containing the ingredients necessary for the preparation of the aforementioned pizza, temporarily opening them so as to release by dropping a predetermined amount of ingredients onto the pizza disc.

By carrying out this operation for each dispensing cylinder, it is clearly possible to obtain a pizza disc topped in the precise manner selected by the user and ready for baking.

Specific examples of topping systems in automatic machines can be traced in patent documents No. WO02100176 and U.S. Pat. No. 6,546,847.

Within these documents automatic pizza preparation machines are specifically described comprising in-line topping systems, that is, developed along a mainly longitudinal direction.

In the present case, the aforementioned patents describe topping systems provided with a plurality of dispensing cylinders, four in the case of WO02100176 and five in the case of U.S. Pat. No. 6,546,847, arranged aligned with each other and each comprising a different ingredient.

Specifically, WO02100176 and U.S. Pat. No. 6,546,847 instruct, once pulled out of the storage area, about how to place the pizza disc on a transport plate which is intended to transport the same towards the topping system.

The transport plate is, therefore, moved longitudinally under the various dispensing cylinders by stopping, in turn, at the point where those are located which are provided with the ingredients required to make the pizza selected by the user.

It should be noted, at this point, that the aforementioned topping systems suffer from some drawbacks and are, therefore, amenable to improvement.

First of all, it is easy to appreciate that the in-line topping systems give, due to their purely longitudinal development, particularly large overall dimensions on known machines.

In particular, these overall dimensions are greater the more dispensing cylinders are comprised in the topping system, and end up, therefore, making the transport, management and installation of known automatic machines somewhat complex and inconveniently difficult.

This drawback evidently represents a serious commercial limitation in the pizza vending industry because it hinders the use of known machines in all those public places that, although small in size, are frequented daily by a large number of potential pizza consumers.

It is also important to mention the fact that the aforementioned topping systems are distinguished sometimes by inaccurate and imprecise operations, which cause some of the ingredients intended for the pizza disc to unintentionally drop on the components of the machine below.

This fact causes a major sanitizing issue that evidently promotes the formation of mold and, in general, the setting of an environment conducive to bacterial proliferation.

Not only that, but this imposes, as an inevitable consequence, frequent machine downtime in order to carry out sanitization of the various components, consequently increasing the total operating costs.

Finally, it is worth highlighting how, within the general scope of the aforementioned known automatic machines, a high amount of plastic package is nowadays used to package pizza discs and/or ingredients, often even arranging each individual pizza disc within a respective plastic package.

It is easy to appreciate how this fact results in a significant waste of resources and is a major promoter of environmental pollution once the plastic package itself is disposed of.

### DESCRIPTION OF THE INVENTION

The main aim of the present invention is to devise a topping system of pizza discs for automatic pizza preparation machines which is provided with reduced overall dimensions and which allows carrying out pizza disc topping effectively and accurately while minimizing the risk of some ingredients intended to be distributed on the pizza disc unintentionally dropping onto the components of the machine below.

Within the aforementioned main aim, the object of the present invention is to devise a compact and easily transportable automatic pizza preparation machine which allows automatic pizzas to be prepared in a short time, at any time of the day and from freshly stored ingredients.

Another object of the present invention is to devise an automatic pizza preparation machine with a low environmental impact.

Another object of the present invention is to devise a topping system of pizza discs for automatic pizza preparation machines which allows the aforementioned drawbacks of the prior art to be overcome within the framework of a simple, rational, easy and effective to use as well as cost-effective solution.

The aforementioned objects are achieved by this topping system of pizza discs for automatic pizza preparation machines having the characteristics of claim 1.

The aforementioned objects are achieved by this automatic pizza preparation machine having the characteristics of claim 12.

### BRIEF DESCRIPTION OF THE DRAWINGS

Other characteristics and advantages of the present invention will become more apparent from the description of a preferred, but not exclusive, embodiment of a topping system of pizza discs for automatic pizza preparation machines, illustrated by way of an indicative, yet non-limiting example, in the accompanying tables of drawings in which:

FIG. 1 is an axonometric, overall view of the machine according to the invention;

FIG. 2 is an axonometric, overall view of the topping system and of the movement system according to the invention;

FIG. 3 is an axonometric, overall view of the topping system of the machine according to the invention;

FIGS. 4, 5, 6 and 7 are cut-away views of details of the topping system of the machine according to the invention.

FIGS. 8 and 9 are axonometric views of the movement system according to the invention in accordance with a first embodiment;

FIG. 10 is an axonometric, detailed view of the movement system according to the invention in accordance with the first embodiment;

FIG. 11 is an axonometric, overall view of the movement system according to the invention in accordance with a second embodiment;

FIGS. 12 and 13 show, in a sequence of front sectional views, the operation of a detail of the movement system according to the invention in accordance with the second embodiment;

FIGS. 14 and 15 show, in a sequence of side views, the operation of another detail of the movement system according to the invention in accordance with the second embodiment.

### EMBODIMENTS OF THE INVENTION

With particular reference to these figures, reference numeral 1 globally indicates an automatic pizza preparation machine.

The automatic pizza preparation machine 1 comprises at least one external structure 2 resting on the ground.

The external structure 2 is substantially a hollow framework within which the main operational components intended to make the pizza are arranged.

Preferably, the external structure 2 is made in the shape of a prism.

Precisely, the external structure 2 is made in the shape of a prism with rectangular faces.

In addition, the machine 1 comprises at least one user interface 3 which is arranged on the external structure 2 and is employable by at least one user at least to select the desired type of pizza.

In actual facts, once the money is entered into the machine 1 (e.g., through a respective slot cut on the external structure 2), it is possible to make the aforementioned selection and consequently to start the preparation of the relevant chosen product.

The user interface 3 can also be configured to show other information to the user, such as the percentage of completion of the pizza preparation, or its nutritional values or still other information.

To enable users to make their own selection, the user interface 3 may have an alphanumeric keypad and/or a touch panel that is sensitive to the touch of the user's fingers (so-called “touch screen”).

Conveniently, the machine 1 comprises a transparent panel 4 which is arranged on the external structure 2 and is employable by the users to look through the latter to enable them to observe the operation of the machine 1 and the preparation of their pizza.

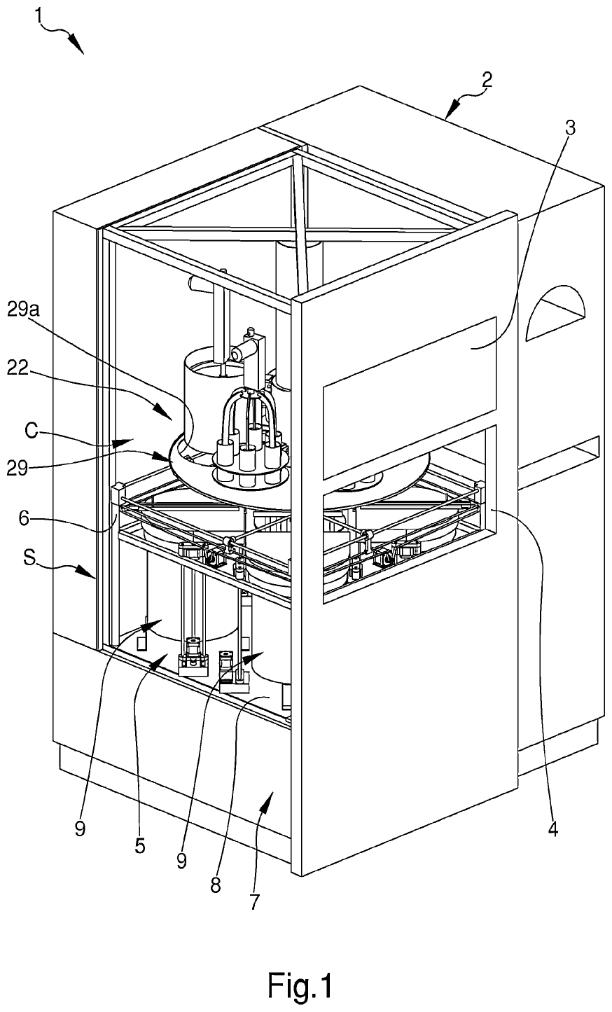

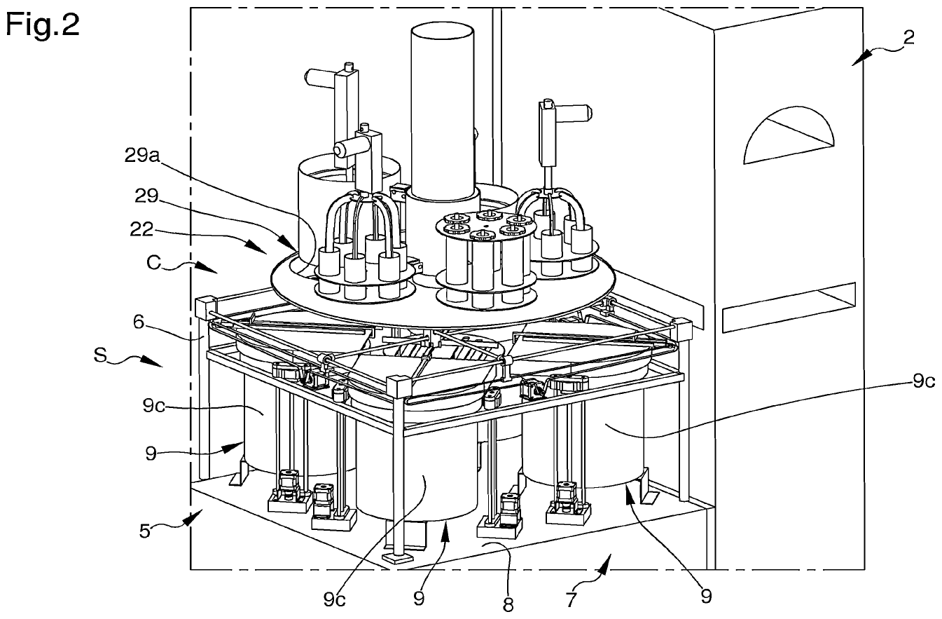

As visible in FIG. 1, the transparent panel 4 is arranged inferiorly to the user interface 3.

That said, it cannot be ruled out that the transparent panel 4 may be arranged in different positions, e.g. next to the user interface 3, or superiorly to the latter.

In addition, the machine 1 comprises at least one movement system 5 of pizza discs for automatic pizza preparation machines.

Specifically, the movement system 5 is arranged internally to the external structure 2.

Going into detail, the movement system 5 comprises:
at least one base frame 6 defining at least one storage area S of pizza discs D;
at least one topping area C of the pizza discs D;

It is good, first of all, to specify that, in the context of the present disclosure, the term “pizza disc” relates to dough made, at least partly, of flour and provided with a substantially discoidal conformation.

In the present case, the pizza discs D are intended to be topped by means of one or more ingredients spread on top and to be, subsequently, baked to obtain a pizza.

The machine 1 comprises at least one refrigeration assembly 7, which is arranged inferiorly to the storage area S and is adapted to keep the pizza discs D stored in the storage area S at least at a predefined refrigeration temperature.

By way of example, the refrigeration temperature can range between 0° C. and 10° C.

That said, however, different refrigeration temperatures, e.g. lower temperatures, cannot be ruled out.

It is easy to appreciate that the provision of a refrigeration assembly 7 enables effective preservation of the pizza discs D stored in the storage area S, thus preserving their organoleptic properties and total safety of consumption.

In this regard, the base frame 6 comprises at least one isothermal panel 8 associated superiorly to the refrigeration assembly 7.

The isothermal panel 8 is made of one or more materials having high thermal resistance (e.g., it can be lined with polyester fiber (PL), sintered expanded polystyrene (EPS) or extruded polystyrene (EPS), expanded polyurethane (PU), expanded polyethylene (PE) and/or foams) and, therefore, provides high thermal resistance in the storage area S, keeping the pizza discs D stored at refrigeration temperature.

The machine 1 is provided with at least one pair of wheels for the movement onto the ground which are associated inferiorly to the refrigeration assembly 7 and can be used to position the machine 1 in different locations according to need and convenience.

It should also be specified that the aforementioned wheels can, conveniently, also be used to slide out the refrigeration assembly 7 and the movement system 5 externally to the external structure 2 by pulling them out of the latter.

This expedient allows one or more operators to carry out any maintenance and repair work on the refrigeration assembly 7 and/or on the movement system 5 very easily, thus reducing the average duration of downtime and, thus, increasing the production output of the latter.

Then, the movement system 5 comprises at least one storage tank 9 located in the storage area S which is provided with at least one outlet port 9a of the pizza discs D and defines at least one containment volume 9b of the pizza discs D within it.

The storage tank 9 is arranged superiorly to the isothermal panel 8.

For example, it is possible to provide one or more holding planes, not shown in the figures, located between the isothermal panel 8 and the storage tank 9 on which the latter is placed resting.

Conveniently, the storage tank 9 is shaped as a right cylinder.

In this sense, the storage tank 9 comprises at least one perimeter wall 9c which is associated inferiorly to the outlet port 9a and the height of which defines the size of the containment volume 9b (i.e., the depth of the storage tank 9).

In actual facts, the greater the height of the perimeter wall 9c, the more pizza discs D it is possible to fit within the containment volume 9b, and vice versa.

According to the preferred embodiment, the perimeter wall 9c has a height which allows the storage tank 9 to hold, when fully loaded, twenty to thirty pizza discs D, however, perimeter walls 9c conformed differently and enabling to hold a larger number of pizza discs D cannot be ruled out.

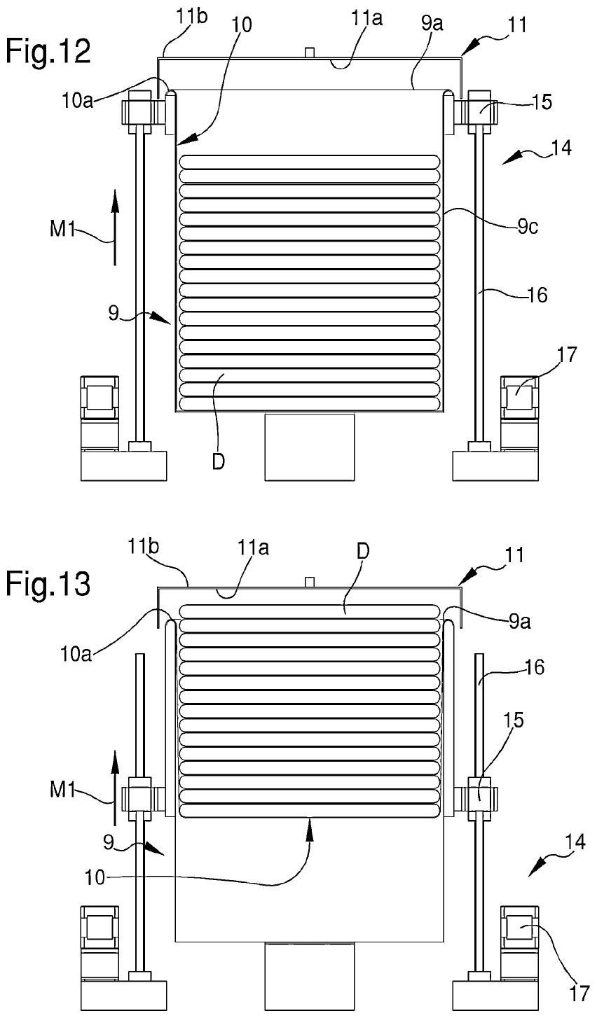

As visible in FIGS. 12 to 13, the pizza discs D are stacked within the containment volume 9b one on top of the other to make a stack of pizza discs D having a height proportional to the number of the latter.

In this regard, it should be added as of now that the pizza discs D are contained within an individual containment package 10 arranged in the containment volume 9b.

For example, the containment package 10 can be made, even partly, of plastic material.

In actual facts, the operator arranges the containment package 10 containing the pizza discs D within the storage tank 9 and, once this is done, opens the top of the containment package 10 (e.g., by tearing it open) to bring the pizza discs D contained therein in communication with the outside.

It is important to point out that providing an individual containment package 10 of the pizza discs D allows for significantly less environmental impact than the prior art (which, as anticipated, often prepares each individual pizza disc D within a respective plastic package), thus reducing resource waste and the amount of plastic to be disposed of.

In the context of the movement system 5, among other things, the fact of providing an individual containment package 10 is particularly useful in ensuring smooth and efficient movement of the pizza discs D, as will be explained later in this disclosure.

In addition, the storage tank 9 comprises at least one lid 11 for closing the outlet port 9a which can be at least partly raised to allow the taking of the pizza discs D out of the containment volume 9b.

In detail, the lid 11 comprises at least one lower face 11a facing, in use, the containment volume 9b and at least one upper face 11b facing, in use, outwards and opposite the lower face 11a.

Having described the storage tank 9 in detail, it is good at this point to specify that the movement system 5 preferably comprises a plurality of storage tanks 9.

As visible in the figures, the movement system 5 comprises four storage tanks 9.

It cannot, however, be ruled out that the movement system 5 may comprise a different number of storage tanks 9, such as three or five.

It should be appreciated that the considerations set forth in this disclosure with regard to only one of the storage tanks 9 (e.g., referring to the latter in the singular) are to be considered equally valid for the other storage tanks 9 and that, regardless of their number, the latter are functionally and structurally completely identical to each other.

In addition, the movement system 5 comprises at least one transport element 12 on which the pizza disc D is positionable.

Conveniently, the transport element 12 is substantially discoidal in shape.

In actual facts, the transport element 12 is of the type of a plate or of a solid body of similar conformation on which it is possible to place the pizza disc D.

In detail, the transport element 12 has a size substantially equal to or greater than the size of the pizza disc D so as to enable the latter to rest on the transport element itself in a smooth and stable manner.

In accordance with a first embodiment, the transport element 12 is arranged in the topping area C.

Therefore, the pizza disc D must first be transferred from the storage area S to the topping area C and only then can it be conveniently placed on the transport element 12.

Precisely for this purpose, according to the invention, the movement system 5 comprises at least one extraction and transfer assembly 13, 14, 18 which is adapted to individually extract the pizza disc D from the containment volume 9b and to transfer it onto the transport element 12.

Specifically, in accordance with the aforementioned first embodiment, the extraction and transfer assembly 13, 14, 18 comprises extraction and transfer means 13 associated with the base frame 6 and comprising at least one gripping device 13a arranged superiorly to the storage tank 9 and configured to retain the pizza disc D and to release the pizza disc D.

Specifically, the extraction and transfer means 13 comprise activation means 13c associated with the gripping device 13a and adapted to enable the activation and deactivation of the latter depending on the gripping and release of the pizza disc D, respectively.

In addition, the gripping device 13a comprises at least one suction cup element 13b operatively connected to the activation means 13c.

Specifically, the activation means 13c are configured to suck in at least one pressurized air flow through the suction cup element 13b so that the vacuum thus established generates a suction force on the pizza disc D.

In fact, in this way, the pizza disc D is pulled out of the containment volume 9b quite smoothly and remains adhered on the suction cup element 13b as long as the activation means 13c generate the mentioned suction force.

Once the activation means 13c have stopped the suction of the pressurized air flow through the suction cup element 13b, the pressure is restored to the ambient value and, therefore, the suction force is zeroed.

This evidently results in the pizza disc D being released from the suction cup element 13b and consequently dropping downwards.

The activation means 13c are of the pump type, e.g., vacuum pumps, but it cannot, however, be ruled out that they may be of a different type known to the expert in the field.

In order to be able to transfer the pizza disc D from the storage area S onto the transport element 12 (which, as mentioned, in this first embodiment is positioned in the topping area C), the extraction and transfer means 13 comprise adjustment means 13d of the height of the suction cup element 13b to which the latter is locked by shifting.

Specifically, the adjustment means 13d are vertically movable between at least one lowered position, wherein the suction cup element 13b is arranged in the storage area S, and at least one raised position, wherein the suction cup element 13b is arranged in the topping area C.

It is, therefore, sufficient to locate the adjustment means 13d in the lowered position and to operate the suction cup element 13b by means of the activation means 13c to suck the pizza disc D out of the containment volume 9b and to place it stopping against the suction cup element itself.

Once this is done, it is sufficient to move the adjustment means 13d from the lowered position to the raised position to transport the pizza disc D from the storage area S to the topping area C.

In this regard, it should be added that when the adjustment means 13d are in the raised position, the suction cup element 13b and, consequently, the pizza disc D attached thereto are arranged higher than where the transport element 12 is located.

With this in mind, it is easy to appreciate that, once in the raised position, it is sufficient to deactivate the suction cup element 13b by means of the activation means 13c to release the pizza disc D from the suction cup element itself and to place it on the transport element 12 by dropping.

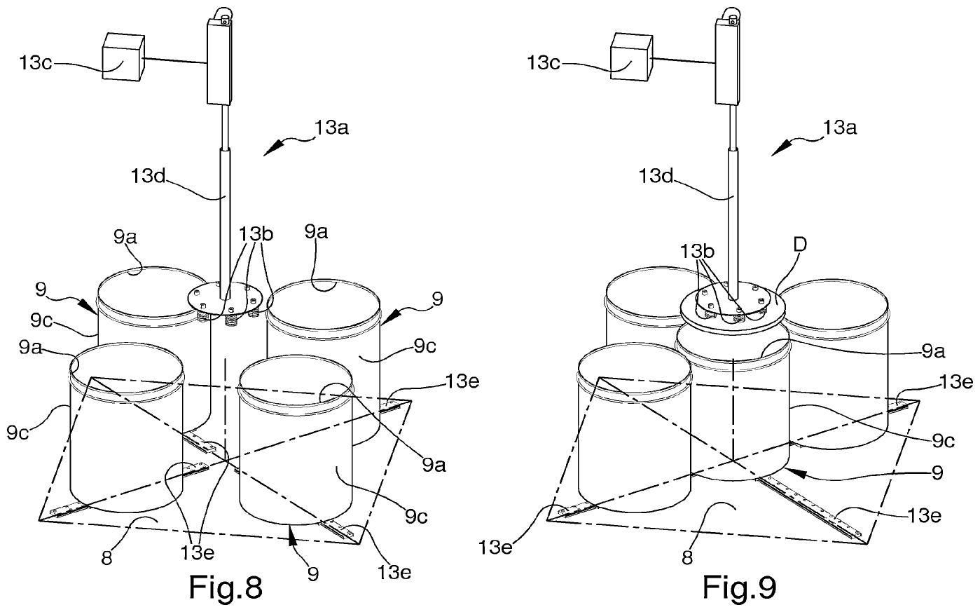

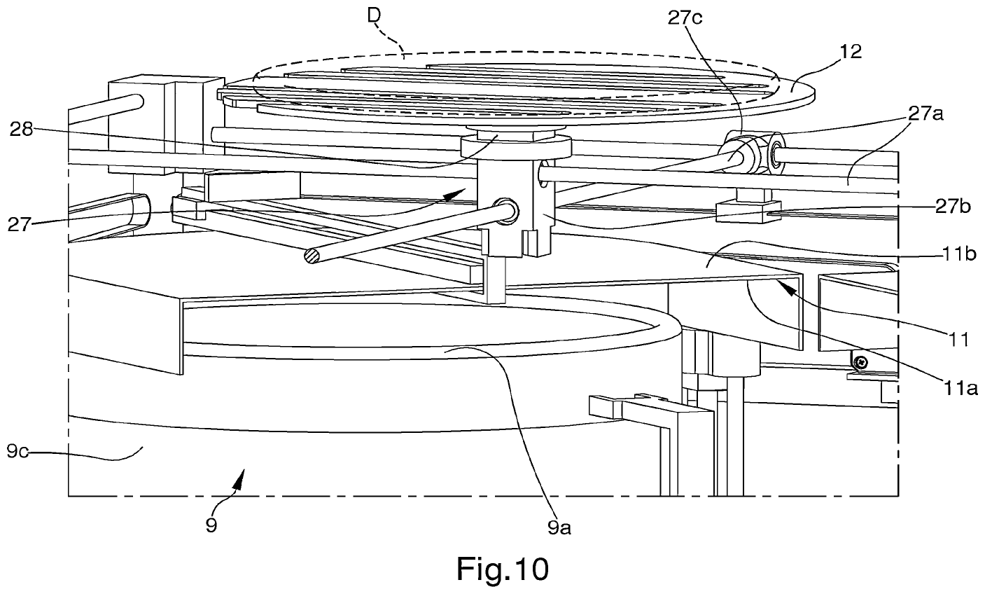

As visible in FIG. 8 and in FIG. 9, the adjustment means 13d are preferably of the type of a linear actuator and/or of an electric cylinder.

In this regard, the adjustment means 13d are maximally extended at the lowered position and are maximally retracted at the raised position.

Once the gripping device 13a has been structurally and functionally described, it should be added that if only one storage tank 9 is provided, it is possible to place the gripping device 13a where the latter is located and, precisely, to align them vertically with each other.

In this way, the operations of pulling the pizza disc D out of the individual containment volume 9b are completely immediate and intuitive, since the gripping device 13a simply has to move vertically to transfer the pizza disc D from the storage area S to the topping area C.

By way of example, it is possible to place the gripping device 13a and the storage tank 9 in the center of the storage area S or, similarly, in still other locations.

If, on the other hand, more than one storage tank 9 is provided, then it is possible to arrange each of these in a different position from that of the gripping device 13a and to transport them, individually and selectively, at the latter, aligning them vertically with each other.

Precisely in this sense, the extraction and transfer means 13 comprise at least one horizontal track 13e with which the storage tank 9 is associated in a sliding manner between at least a first predefined position, wherein the storage tank 9 is vertically misaligned with respect to the gripping device 13a, and at least a second predefined position, wherein the storage tank 9 is vertically aligned with the gripping device 13a.

In particular, the horizontal track 13e is arranged resting superiorly to the isothermal panel 8.

It is then possible to make any one of the storage tanks 9 slide along the horizontal track 13e from the first predefined position to the second predefined position and activate, at that point, the gripping device 13a, to effectively transfer the pizza disc D from the storage area S to the topping area C.

For example, if the aforementioned storage tank 9 contains more than one pizza disc D, then it can be conveniently kept in the second predefined position until the gripping device 13a has pulled out each and every pizza disc D from its respective containment volume 9b.

Once the pizza discs D contained therein have been exhausted, that storage tank 9 can be returned to the first predefined position and transport another storage tank 9 from the first predefined position to the second predefined position.

It is easy to appreciate how this operational methodology allows for the preparation of a large number of pizzas in an absolutely intuitive and efficient manner.

In accordance with a second embodiment, alternative to the previous one, the transport element 12 is movable between the storage area S and the topping area C.

Therefore, in this case, once the transport element 12 is placed in the storage area S, it is sufficient to locate the pizza disc D on the latter and move the transport element and the pizza disc D towards the topping area C.

To place the pizza disc D on the transport element, the extraction and transfer assembly 13, 14, 18 first of all comprises first movement means 14 which are associated with the storage tank 9 and are adapted to move the pizza disc D along at least a first substantially vertical direction of movement M1 from at least one home position, wherein the pizza disc D is contained in the containment volume 9b, to at least one working position, wherein the pizza disc D is extracted from the containment volume 9b and is positioned at the point where the outlet port 9a is located.

In the home position, therefore, the pizza disc D is higher than the outlet port 9a; once the first movement means 14 have been actuated, the disc is raised with respect to such height and is placed at substantially the same height as the outlet port 9a, outside the containment volume 9b.

If a plurality of pizza discs D is contained within the storage tank 9, then the first movement means 14 can be operated to bring the pizza disc D so as to arrange, of all, highest from the home position to the working position.

For this purpose, the first movement means 14 comprise at least one pair of clamping elements 15 which are arranged in opposite positions to each other on the perimeter wall 9c of the storage tank 9 and are attachable to at least one portion 10a of the containment package 10 of the pizza disc D at least partly inserted into the containment volume 9b.

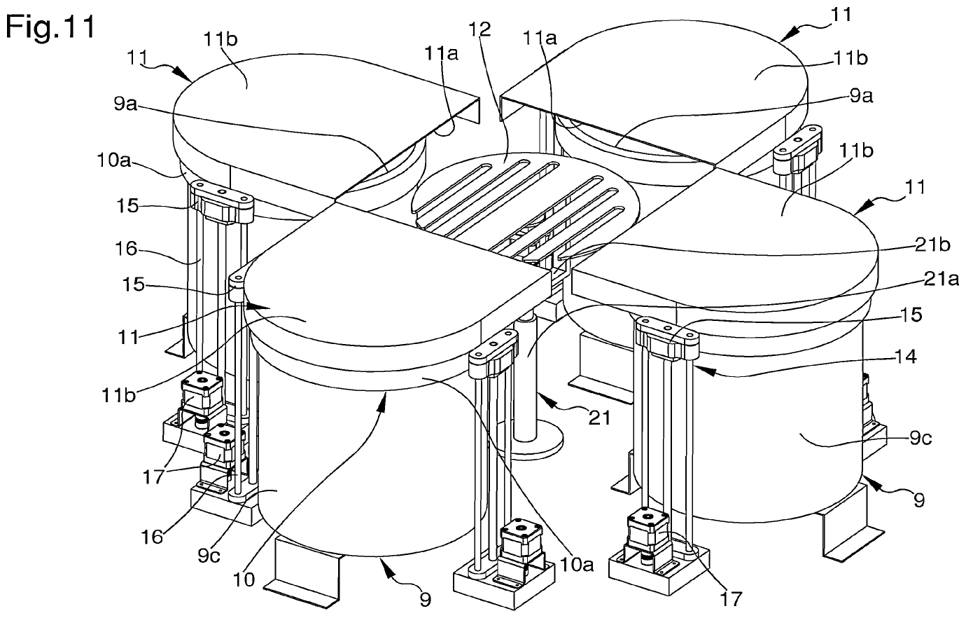

As visible in FIGS. 11 through 13, the portion 10a of the package is, in actual facts, a flap of the containment package 10, obtained as a result of the operator opening the latter.

The first movement means 14 then comprise, at least, a vertical guide 16 running longitudinally along the storage tank 9 and on which the clamping elements 15 are mounted in a movable manner between the home position and the working position.

Thus, the clamping elements 15 can be moved vertically along the vertical guide 16.

Precisely, as is clear by comparing FIG. 12 with FIG. 13, the clamping elements 15 are lowered and moved closer, therefore, to the ground to bring the pizza disc D from the home position to the working position.

In doing so, the portion 10a of containment package 10 attached thereto is dragged downwards due to the sliding of the clamping elements 15 along the vertical guide 16.

This fact evidently implies that the entire containment package 10 is dragged along with the portion 10a and which, in doing so, it raises with respect to the bottom of the storage tank 9.

In this way, the pizza disc D contained in the containment package 10 is also raised and increases, locked together with the latter, its height with respect to the bottom of the storage tank 9 as far as it is placed in the working position.

In actual facts, the movement of the clamping elements 15 along the first direction of movement M1 has opposite direction (i.e., from top to bottom), in the transition from the home position to the working position, than that of the pizza disc D (i.e., from bottom to top).

Conveniently, the first movement means 14 comprise two vertical guides 16 which are arranged in opposite positions to each other on the perimeter wall 9c of the storage tank 9.

In particular, the position of the vertical guides 16 corresponds to that of the clamping elements 15.

In actual facts, one of the vertical guides 16 is associated with one of the clamping elements 15, and the other of the vertical guides 16 is associated with the other of the clamping elements 15.

Preferably, the vertical guides 16 are of the worm screw type which can be operated in axial rotation to move the clamping elements 15 between the home position and the working position.

For this purpose, the first movement means 14 comprise at least one motorized unit 17 operatively connected to the vertical guides 16.

Conveniently, the first movement means 14 comprise two motorized units 17, one motorized unit 17 being operatively connected to a vertical guide 16 and the other motorized unit being operatively connected to the other vertical guide 16. Specifically, the motorized units 17 are of the electric motor type.

The extraction and transfer assembly 14, 18 comprises, in addition, second movement means 18 which are associated with the lid 11 and are adapted to move the pizza disc D along at least one second substantially horizontal direction of movement M2 from the working position to at least one transport position, wherein the pizza disc D is positioned on the transport element 12.

The second movement means 18 therefore move the pizza disc D along a direction substantially orthogonal to the first direction of movement M1, thus enabling its placement on the transport element 12.

In detail, the second movement means 18 comprise:
at least one horizontal guide 19 running along the second direction of movement M2;
at least one thrust body 20 which is associated with the horizontal guide 19 in a movable manner and is adapted to push the pizza disc D from the working position to the transport position.

The horizontal guide 19 is associated with one of either the lower face 11a or the upper face 11b.

Preferably, as shown in the figures, the horizontal guide 19 is preferably associated with the upper face 11b.

In particular, the horizontal guide 19 runs substantially along the entire length of the upper face 11b.

As for the thrust body 20, it comprises at least one sliding portion 20a mounted on the horizontal guide 19 in a sliding manner and associated with one of either the lower face 11a or the upper face 11b.

Keeping in mind what has been said about the horizontal guide 19, it is easy to appreciate that the sliding portion 20a is also associated with the upper face 11b.

The thrust body 20 then comprises, at least, a stopping portion 20b which is positioned between the lower face 11a and the outlet port 9a and is intended, in use, to contact the pizza disc D and to push it onto the transport element 12 due to the sliding of the sliding portion 20a along the horizontal guide 19.

The stopping portion 20b has a substantially widened conformation that enables it to push the pizza disc evenly and move the latter from the working position to the transport position.

Advantageously, the thrust body 20 comprises at least one connecting portion 20c which is located between the sliding portion 20a and the stopping portion 20b.

The connecting portion 20c is preferably substantially conformed to a “U” shape.

In this regard, to say that the connecting portion 20c is substantially conformed to a “U” shape is to mean that it comprises two horizontal stretches which are parallel to the second direction of movement M2 and a vertical stretch, located between the previous two, which is parallel to the first direction of movement M1.

In this sense, the connecting portion 20c and the sliding portion 20a are arranged at the ends of the straight stretches (i.e., at the ends of the connecting portion 20c).

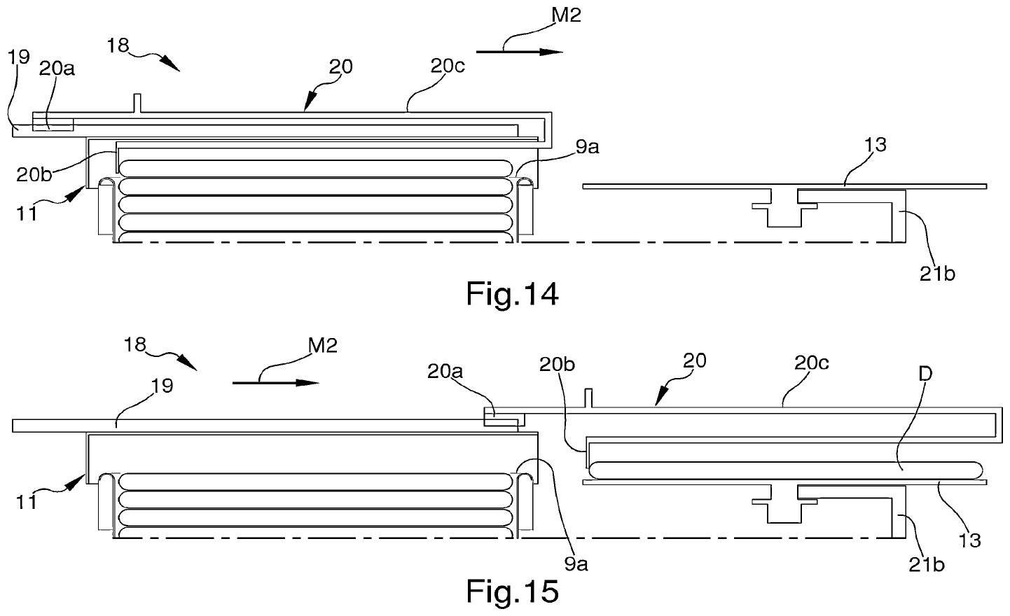

In describing the operation of the second movement means 18, it should first be said that, as is clear by observing FIG. 14, the thrust body 20 is fully retracted along the horizontal guide 19 (i.e., it is arranged at the maximum distance from the transport element 12) when the pizza disc D is in the working position.

The aforementioned position of the thrust body 20 causes the pizza disc D to be located along the second direction of movement M2 between the stopping portion 20b and the transport element 12 in the working position.

By actuating the second movement means 18, the sliding portion 20a slides along the horizontal guide 19 and drags the stopping portion 20b along the second direction of movement M2, making it contact the pizza disc D to exert a thrust force on the latter directed towards the transport element 12.

As shown in FIG. 15, the thrust body 20 is fully extended along the horizontal guide 19 (i.e., it is arranged at the minimum distance from the transport element 12) once the pizza disc D has been arranged in the transport position.

At this point, the thrust body 20 can be returned to the previously described retracted position, e.g., to enable it to push another pizza disc D on the transport element 12 later on.

Once the pizza disc D is located in the transport position, the latter can then be transported towards the topping area C.

To do this, the movement system 5 comprises at least one transport assembly 21 associated with the transport element 12 and adapted to transport the latter along a substantially vertical direction between at least a first reference position, wherein the transport element 12 is positioned in the storage area S, and at least a second reference position, wherein the transport element 12 is positioned in the topping area C.

This means that the topping area C and the storage area S are vertically aligned with each other.

This particular expedient makes it possible to significantly reduce the longitudinal overall dimensions of the movement system 5 and, consequently, of the machine 1 compared with the prior art, enabling the latter to be used profitably even within small public places.

Specifically, the transport assembly 21 comprises at least one actuator device 21 which is movable along the first direction of movement M1 to move the transport element 12 from the first reference configuration to the second reference configuration and vice versa.

The actuator device 21 is, for the purpose, provided with a fixed end 21a with respect to the base frame 6 and with a movable end 21b, associated with the fixed end 21a in a movable manner, between the first reference configuration and the second reference configuration.

Specifically, the movable end 21b is fastened to the transport element 12.

This means that when the movable end 21b is moved with respect to the fixed end 21a, then the transport element 12 is also moved locked together with the movable end 21b with respect to the fixed end 21a.

In this case, the movable end 21b is extendable with respect to the fixed end 21a to bring the transport element 12 from the first reference position to the second reference position.

Similarly, the movable end 21b is retractable with respect to the fixed end 21a to bring the transport element 12 from the second reference position to the first reference position.

It follows that, in the preferred embodiment shown in the figures, the topping area C is arranged superiorly to the storage area S.

The alternative embodiment wherein, in particular, the topping area C is arranged inferiorly to the storage area S cannot however be ruled out.

As the movement system 5 has been described before, it is good to say at this point that the machine 1 comprises at least one topping system 22 of the pizza discs D which is located in the topping area C.

Specifically, the topping system 22 comprises a plurality of dispensing cylinders 23, 24, 25, 26, each containing at least one ingredient which is usable as a topping for the pizza disc D and is deliverable by dropping onto the latter.

It is important to specify that the dispensing cylinders 23, 24, 25, 26 are provided with various and different diameters from each other but have in common that they are all smaller than the diameter of the pizza disc D.

In fact, this allows the desired amount of ingredients to be dispensed from the dispensing cylinders 23, 24, 25, 26 onto the pizza disc D while ensuring that the perimeter edge of the latter is not topped.

As can be seen by looking at the figures, the dispensing cylinders 23, 24, 25, 26 are arranged parallel to each other around at least one substantially vertical common central axis A.

In fact, this expedient makes it possible to create a space-saving topping system 22 which, again, allows the machine 1 to be used profitably even within small public places.

According to the invention, the topping system 22 comprises positioning means 27 which are arranged inferiorly to the dispensing cylinders 23, 24, 25, 26 and are adapted to position the pizza disc D at least at the point where each of the dispensing cylinders 23, 24, 25, 26 is located.

Specifically, the positioning means 27 comprise:
at least one pair of movable rods 27a lying in a substantially horizontal lying plane and arranged substantially orthogonal to each other, the movable rods 27a being movable along substantially horizontal mutual directions and orthogonal to each other; and
at least one coupling element 27b which is mounted on the movable rods 27a in a sliding manner and is attachable to the transport element 12.

Specifically, each of the movable rods 27a is associated with the base frame 6 in a movable manner.

More specifically, the positioning means 27 comprise at least two pairs of sliding bushings 27c mounted in a sliding manner to the base frame 6 and with which the movable rods 27a are locked together by shifting.

Specifically, one movable rod 27a is locked by shifting together with one pair of sliding bushings 27c and the other movable rod 27a is locked by shifting together with the other pair of sliding bushings 27c.

In the present case, and quite similarly to the movable rods 27a, the two pairs of sliding bushings 27c slide on the base frame 6 along mutual directions which are substantially horizontal and orthogonal to each other.

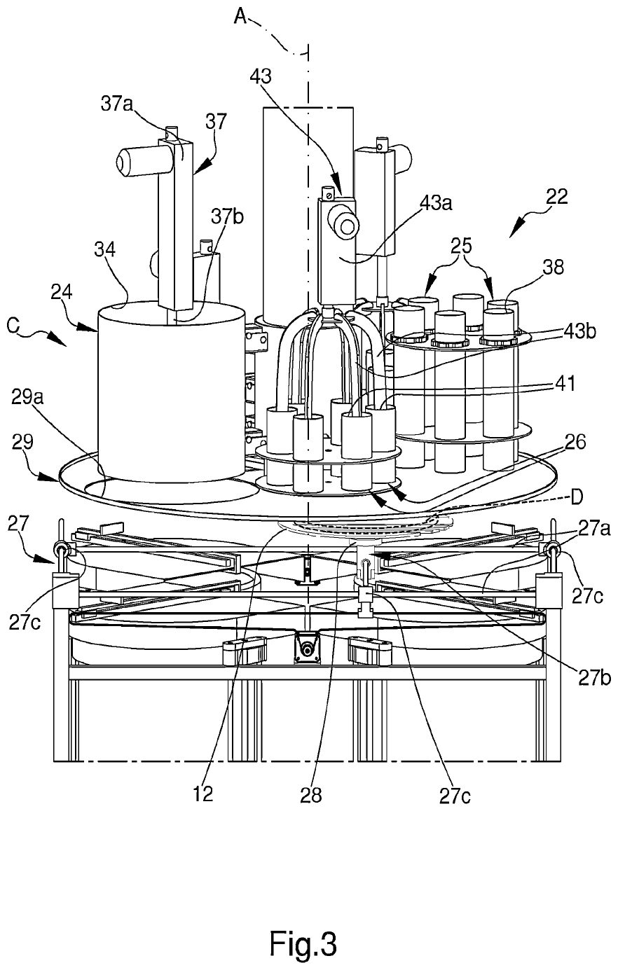

As visible in FIG. 3, each sliding bushing 27c is arranged at one end of the respective movable rod 27a.

This means, in other words, that each movable rod 27a is located between the respective two sliding bushings 27c.

It is good to explain at this point that the positioning means 27 are arranged at a slightly lower height than that at which the transport element 12 is in the second reference position.

The aforementioned height of the positioning means 27 is, in particular, such that the coupling element 27b attaches inferiorly to the transport element 12.

Once attached, the transport element 12 can be detached from the movable end 21b of the actuator device 21, e.g., by simple slipping off.

At this point, the movable end 21b without the transport element 12 may be retracted from the fixed end 21a and returned, therefore, to the storage area S.

It is easy to appreciate, in this regard, that the transport element 12 attached on the coupling element 27b can be moved under the dispensing cylinders 23, 24, 25, 26 due to the sliding of the pair of movable rods 27a.

In fact, the particular arrangement of the movable rods 27a allows moving the coupling element 27b and, therefore, the transport element 12 substantially anywhere within a rectangular area that lies on the horizontal lying plane and has a dimension defined by the amplitude of the strokes of the movable rods 27a.

Conveniently, the coupling element 27b is provided with at least one ball joint 28.

In this way, in fact, it is possible to set in rotation the transport element 12 attached to the coupling element 27b, as well as the pizza disc D arranged superiorly thereto, with respect to a substantially vertical axis.

This expedient is particularly useful since it allows the ingredients dispensed by the dispensing cylinders 23, 24, 25, 26 to be evenly distributed on top of the pizza disc D.

In fact, it is sufficient to move the coupling element 27b to the point where a dispensing cylinder 23, 24, 25, 26 is located and drive the transport element 12 in rotation to cause the ingredients be distributed on the pizza disc D evenly over its entire surface.

To avert the risk of some of the topping dispensed by the dispensing cylinders 23, 24, 25, 26 inadvertently dropping off the pizza disc D and onto the components of the machine 1 below, the topping system 22 comprises at least one selector disc 29 which is rotatable around the central axis A and is positioned between the positioning means 27 and the dispensing cylinders 23, 24, 25, 26.

Specifically, the selector disc 29 is provided with at least one selector hole 29a which may be selectively aligned with each of the dispensing cylinders 23, 24, 25, 26 and traversable by the ingredients delivered on the pizza disc D.

It is, therefore, sufficient to rotate the selector disc 29 until the selector hole 29a is arranged where a special dispensing cylinder 23, 24, 25, 26 is located to allow the desired topping to be dispensed by the latter onto the pizza disc D placed there.

Once delivery has finished, the selector disc 29 can be rotated again, e.g. by aligning the selector hole 29a with another dispensing cylinder 23, 24, 25, 26.

In this way, if other ingredients inadvertently drop off the previous dispensing cylinder 23, 24, 25, 26, then the latter are intercepted by the selector disc 29 and end up depositing on the latter.

This ensures that the components underneath the dispensing cylinders 23, 24, 25, 26 remain clean, and, therefore, significantly less downtime is required for their sanitization than the prior art.

It is worth pointing out, in this regard, that the aforementioned sanitizing operations are quite simple to perform, as it is sufficient to disassemble and clean the selector disc 29 only.

Ultimately, the fact of providing a selector disc 29 allows not only the frequency but also the duration of downtime to be reduced compared with the aforementioned prior art.

Going down to the details of the dispensing cylinders 23, 24, 25, 26, they comprise at least a first dispensing cylinder 23 comprising at least a first chamber 30 containing topping in the form of tomato sauce gel and first delivering means 31, 32, 33 associated with the first chamber 30 which are adapted to deliver at least part of the tomato sauce contained therein onto the pizza disc D.

In the present case, the first delivering means 31, 32, 33 comprise at least one outlet matrix 31 associated inferiorly to the first chamber 30 which is adapted to extrude the tomato sauce and is provided with a plurality of outlet holes 32 traversable by the extruded tomato sauce to be delivered outside.

Precisely, the outlet matrix 31 is mounted on the first chamber 30 so as to close the latter inferiorly and thus to bound an internal volume in the first chamber 30 which can be filled, at least partly, by the tomato sauce.

With this in mind, it is easy to appreciate that the outlet matrix 31 is substantially circular in shape.

In addition, the outlet holes 32 are evenly distributed on the surface of the outlet matrix 31 so that the tomato sauce can be evenly extruded and delivered outwards.

Specifically, the outlet holes 32 are spirally distributed on the surface of the outlet matrix 31.

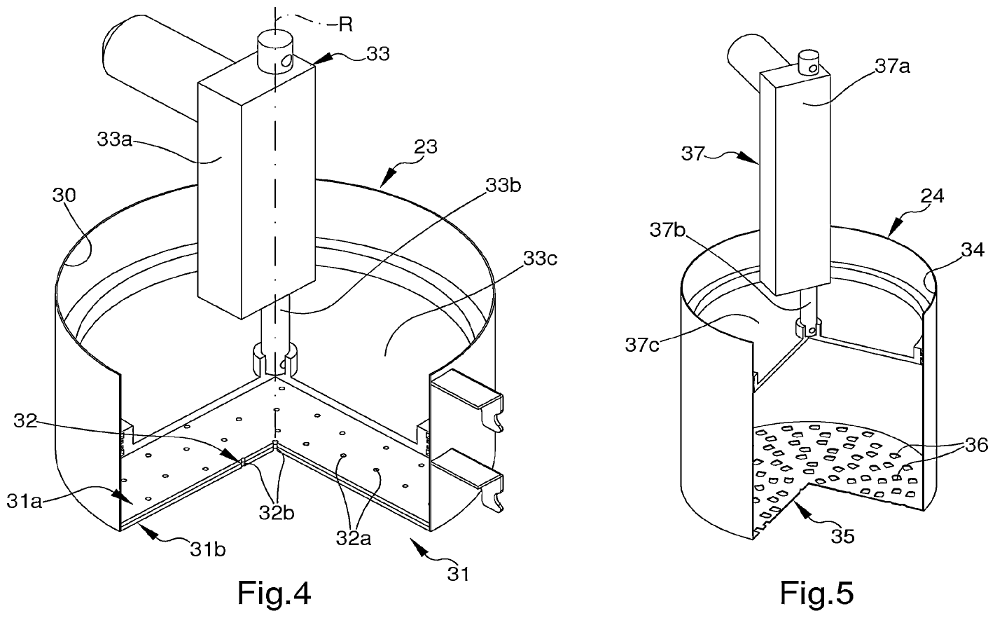

Conveniently, as visible in FIG. 4, the outlet matrix 31 comprises at least a first outlet matrix 31a and at least a second outlet matrix 31b which are provided with a plurality of first outlet holes 32a and of second outlet holes 32b respectively which can be traversed by the tomato sauce.

In addition, the first outlet matrix 31a and the second outlet matrix 31b are mutually rotatable with respect to an axis of rotation R substantially vertical and passing through the first chamber 30, between at least one opening position, wherein the first outlet holes 32a and the second outlet holes 32b are aligned, and at least one closure position, wherein the first outlet holes 32a and the second outlet holes 32b are misaligned.

The first outlet matrix 31a and the second outlet matrix 31b are superimposed along a substantially vertical direction; therefore, the relevant rotation of one with respect to the other results in the alignment or misalignment of the first outlet holes 32a and of the second outlet holes 32b.

By aligning the first outlet holes 32a and the second outlet holes 32b with each other in the first opening position, it is therefore possible to put the first chamber 30 in communication with the outside and, in this way, to allow the extruded tomato sauce to flow out.

It is important to point out that the special expedient of providing a first outlet matrix 31a and a second outlet matrix 31b allows the length of the extruded tomato sauce flowing out of the outlet holes 32 to be adjusted quite efficiently and intuitively.

In fact, it is easy to appreciate that it is sufficient to rotate the first outlet matrix 31a and the second outlet matrix 31b with respect to each other around the axis of rotation R so that the first outlet holes 32a and the second outlet holes 32b are only partly misaligned with each other in order for the tomato sauce escaping from the outlet holes themselves to be cut crosswise.

Substantially, by selectively aligning and partly misaligning the first outlet holes 32a and the second outlet holes 32b with each other, it is possible to deliver the extruded tomato sauce having a specific length which is determined, in particular, by the frequency with which the alignment and partial misalignment are alternated.

Once a predetermined amount of tomato sauce has been delivered, it is possible to rotate the first outlet matrix 31a and the second outlet matrix 31b with respect to each other to such an extent that the first outlet holes 32a and the second outlet holes 32b are totally misaligned with each other and, in so doing, prevent unintentional drips of additional tomato sauce from the outlet holes 32 onto the components of the machine 1 below.

In order to exert sufficient compressive force on the tomato sauce to deliver it outwards, the first delivering means 31, 32, 33 comprise at least a first piston 33 arranged superiorly to the outlet matrix 31 and extendable to compress the tomato sauce against the outlet matrix 31, forcing it through the outlet holes 32.

The first piston 33 specifically comprises at least a first fixed portion 33a with respect to the first chamber 30 and at least a first movable portion 33b which is movable vertically with respect to the first fixed portion 33a.

Specifically, the first movable portion 33b is extendable with respect to the first fixed portion 33a to exert compressive force on the tomato sauce, and is retractable with respect to the first fixed portion 33a to stop compression.

Specifically, the first movable portion 33b is provided with at least a first enlarged end 33c sized so as to slide to fit the first chamber 30.

As a result of the movement of the first enlarged end 33c, therefore, compressive force can be exerted on the tomato sauce contained in the first chamber 30 so that the tomato sauce itself is pushed downwards and, in particular, towards the outlet matrix 31.

It is, therefore, easy to appreciate that it is sufficient to align the first outlet holes 32a and the second outlet holes 32b with each other and to operate, at that point, the first piston 33 to exert enough compressive force on the tomato sauce so as to extrude it through the outlet matrix 31.

Once the delivery of the tomato sauce has finished, the first movable portion 33b can be retracted towards the first fixed portion 33a to stop the application of the mentioned compressive force on the tomato sauce and thus to prevent further tomato sauce from inadvertently flowing out of the first chamber 30.

The operation just described can be done at the same time as the total misalignment of the first outlet holes 32a with the second outlet holes 32b, or it can be done at a different time, e.g. previously.

In the embodiment shown in the figures, the dispensing cylinders 23, 24, 25, 26 comprise an individual first dispensing cylinder 23.

However, it is easy to appreciate how the number of first dispensing cylinders 23 may be varied substantially at will and that it is, therefore, also possible to comprise a plurality of first dispensing cylinders 23 within the topping system 22.

Conveniently, as shown in FIG. 5, the dispensing cylinders 23, 24, 25, 26 comprise at least a second dispensing cylinder 24 comprising at least a second chamber 34 containing at least one wheel of stretched cheese and second delivering means 35, 36, 37 associated with the second chamber 34 which are adapted to dispense at least part of stretched cheese onto the pizza disc D.

Preferably, the stretched cheese is of the mozzarella type, but it cannot be ruled out that it can also be of different types such as, e.g., of the scamorza, provolone and/or caciocavallo type.

Detailing the second delivering means 35, 36, 37, it can be appreciated that they comprise at least one grating body 35 associated inferiorly to the second chamber 34 which body is adapted to obtain a plurality of shreds of stretched cheese and is provided with a plurality of cutting slots 36 which can be passed through by the shreds for the delivery of the latter outwards.

In much the same way as with the outlet matrix 31, the grating body 35 is mounted on the second chamber 34 so as to close the latter inferiorly and thus to bound an internal volume to the second chamber 34 that can be filled, at least partly, by the stretched cheese.

With this in mind, it is easy to appreciate that the grating body 35 is substantially circular in shape.

The cutting slots 36 are evenly distributed on the surface of the grating body 35 so as to cut the stretched cheese equally evenly for the delivery of the latter outwards.

The second delivering means 35, 36, 37 then comprise at least a second piston 37 arranged superiorly to the grating body 35 and extendable to compress the stretched cheese against the grating body 35, forcing it through the cutting slots 36.

The second piston 37 comprises, in detail, at least a second fixed portion 37a with respect to the second chamber 34 and at least a second movable portion 37b which is movable vertically with respect to the second fixed portion 37a.

Specifically, the second movable portion 37b is extendable with respect to the second fixed portion 37a to exert the compressive force on the stretched cheese, and is retractable with respect to the second fixed portion 37a to stop compression.

In particular, the second movable portion 37b is provided with at least a second enlarged end 37c sized so as to slide to fit the second chamber 34.

As a result of the movement of the second enlarged end 37c, therefore, compressive force is exerted on the stretched cheese contained in the second chamber 34 so as to push it downwards and, in particular, towards the grating body 35.

In this way, it is clearly possible to cut the stretched cheese forced against the cutting slots 36 and thus to deliver the resulting shreds of stretched cheese outside onto the pizza disc.

In the embodiment shown in the figures, the dispensing cylinders 23, 24, 25, 26 comprise an individual second dispensing cylinder 24.

It is, however, easy to appreciate how the number of second dispensing cylinders 24 mat be varied substantially at will and it is, therefore, also possible to comprise a plurality of second dispensing cylinders 24 within the topping system 22.

In this regard, a second dispensing cylinder 24 may be provided containing mozzarella cheese and another second dispensing cylinder 24 containing another stretched cheese, such as provolone cheese.

Advantageously, the dispensing cylinders 23, 24, 25, 26 comprise at least a third dispensing cylinder 25 comprising at least a third chamber 38 containing vegetables and third delivering means 39, 40 associated with the third chamber 38 which are adapted to deliver at least part of the vegetables on the pizza disc D.

For example, vegetables can be placed by the operator inside the third chamber 38 already cut and at least partly cooked.

Conveniently, the third delivering means 39, 40 comprise at least one portioning chamber 39 which is associated inferiorly to the third chamber 38 and is communicating with the latter, the portioning chamber 39 being filled with the vegetables and having at least one lower opening 39a for the delivery of the vegetables outwards.

The portioning chamber 39 has, in particular, substantially the same width as the third chamber 38 and a lower height than the latter and proportionate to the amount of vegetables to be dispensed on the pizza disc D.

In this regard, in fact, it is good to explain the fact that the lower opening 39a is openable as a result of the filling of the portioning chamber 39; this means that the greater the height of the portioning chamber 39, the greater the amount of vegetables it can hold and, therefore, dispense on the pizza disc D once the lower opening 39a is opened, and vice versa.

To enable this to occur, the lower opening 39a can be of the type of a rotating flap which can be opened upon reaching a predetermined weight value of vegetables weighing down on top of it.

Alternatively, the lower opening 39a can be associated with one or more load cells operatively connected to an electronic unit configured to open the lower opening 39a once the predetermined weight value of vegetables has been reached, or it can be of other types still known to the expert in the field.

The third delivering means 39, 40 then comprise at least one feeding screw device 40 arranged within the third chamber 38 and operable by rotation to transfer at least part of the vegetables from the third chamber 38 to the portioning chamber 39.

Through its own rotation, the feeding screw device 40 collects a certain amount of vegetables on its propellers.

Such vegetables move forward, in each revolution, by a distance equal to the pitch of the feeding screw device 40 (i.e., the distance between two adjacent propellers of the feeding screw device 40) until, having arrived where the portioning chamber 39 is located, it is made to drop inside the latter.

The energy required to rotate the feeding screw device 40 can be provided by motorized means connected thereto, e.g. of the type of electric motors.

The feeding screw device 40 is, therefore, made to rotate to an extent corresponding to the amount of vegetables that it, precisely because of its rotation, must introduce into the empty portioning chamber 39 to fill it.

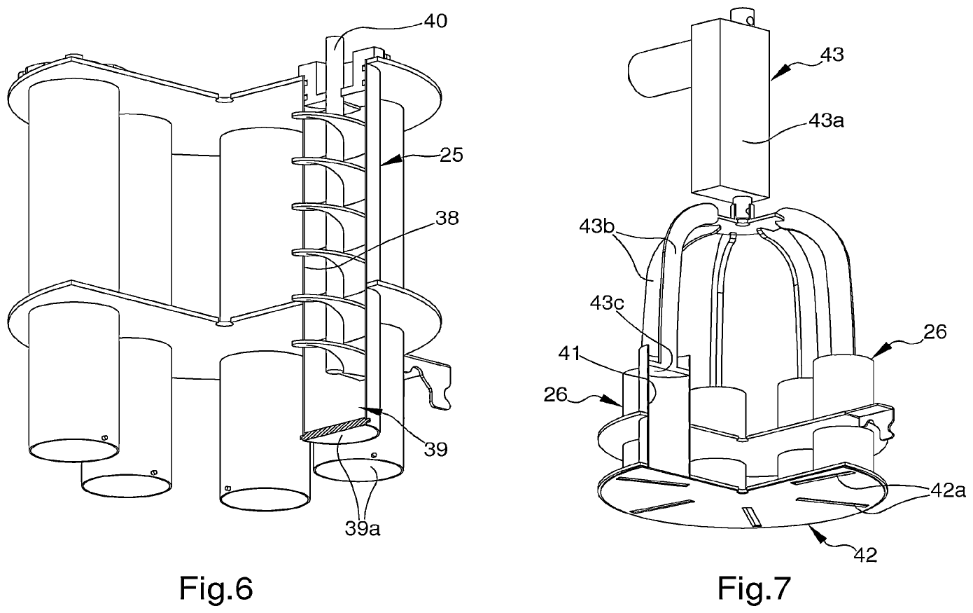

In accordance with the preferred embodiment shown in FIG. 6, the dispensing cylinders 23, 24, 25, 26 comprise a plurality of third dispensing cylinders 25.

Precisely, as shown in the figures, the dispensing cylinders 23, 24, 25, 26 comprise six third dispensing cylinders 25.

In the present case, three of the six third dispensing cylinders 25 are arranged circumferentially with respect to each other around a common center, and the other three of the six third dispensing cylinders 25 are arranged circumferentially with respect to each other around another common center different from the previous one.

For example, the two common centers can be placed a few millimeters apart.

The special arrangement of the six third dispensing cylinders 25 allows distributing the ingredients contained within the third chambers 38 on the pizza disc D below in a more even manner.

It cannot, however, be ruled out that all six third dispensing cylinders 25 may be arranged circumferentially around an individual common center.

Each of the six third dispensing cylinders 25 can be filled with vegetables of different kind (e.g., broccoli, spinach, onion, peppers, zucchini, mushrooms, and so on).

However, it is easy to appreciate how the number of third dispensing cylinders 25 may be varied substantially at will from what is shown in the figures and it is, e.g., possible to provide for even a larger number thereof.

In all cases, it is possible to activate/deactivate each of the third delivering means 39, 40 of each third dispensing cylinder 25 simultaneously to deliver on the pizza disc a portion of mixed vegetables and/or to activate/deactivate only some of the third delivering means 39, 40 simultaneously.

Conveniently, the dispensing cylinders 23, 24, 25, 26 comprise at least a fourth dispensing cylinder 26 comprising at least a fourth chamber 41 containing cold cuts.

Preferably, the cold cuts are of the type selected from the list comprising: salami, cooked ham, cured ham, coppa, bacon and so on.

Advantageously, the dispensing cylinders 23, 24, 25, 26 comprise a plurality of fourth dispensing cylinders 26.

In the present case, the fourth dispensing cylinders 26 are grouped together to define a set of fourth dispensing cylinders 26.

In accordance with the preferred embodiment, the dispensing cylinders 23, 24, 25, 26 comprise six fourth dispensing cylinders 26.

Specifically, in accordance with the aforementioned preferred embodiment, three of the fourth dispensing cylinders 26 are arranged circumferentially around a common center, and the other three of the fourth dispensing cylinders 26 are arranged circumferentially around another common center different from the previous one.

For example, the two common centers may be placed a few millimeters apart.

The special expedient of the six fourth dispensing cylinders 26 allows distributing the ingredients contained within the fourth chambers 41 on the pizza disc D below in a more even manner.

It cannot, however, be ruled out that all six fourth dispensing cylinders 26 can be arranged circumferentially around an individual common center.

All the six fourth dispensing cylinders comprise the same type of cold cuts, e.g., salami.

Preferably, the dispensing cylinders 23, 24, 25, 26 comprise two sets of fourth dispensing cylinders 26, each of the two sets of fourth dispensing cylinders 26 comprising six fourth dispensing cylinders 26 arranged with respect to each other according to the above manner.

For example, it is possible to fill the six fourth dispensing cylinders 26 of one set with the same cold cuts, e.g., salami, and fill the other six fourth dispensing cylinders 26 of the other set with different cold cuts, e.g., ham.

Each set of fourth dispensing cylinders 26 comprises, then, fourth delivering means 42, 43 which are associated with each fourth chamber 41 and are adapted to deliver at least part of the cold cuts contained therein onto the pizza disc D.

Detailing the fourth delivering means 42, 43, it is good to say that they comprise at least one slicing body 42 associated inferiorly to each fourth chamber 41 which is adapted to obtain a plurality of slices of cold cuts and is provided with at least one slicing port 42a which can be crossed by the slices of cold cuts for dispensing the latter outwards.

In much the same way as with the outlet matrix 31 and the grating body 35, the slicing body 42 is arranged underneath all the fourth chambers 41 so as to close them below and thus to bound six internal volumes which can be filled, at least partly, by the cold cuts.

Preferably, the slicing body 42 is substantially circular in shape.

In addition, the slicing body 42 is of such a size that it closes, at the same time, all six fourth dispensing cylinders 26 below.

The fourth delivering means 42, 43 then comprise at least a third piston 43 arranged superiorly to the slicing body 42 and extendable to compress the cold cuts against the slicing body 42, forcing them through the slicing port 42a.

The third piston 43 comprises, in detail, at least a third fixed portion 43a with respect to the fourth chamber 41 and a plurality of third movable portions 43b, which move vertically with respect to the third fixed portion 43a.

Specifically, the third movable portion 43b is extendable with respect to the third fixed portion 43a to exert compressive force on the cold cuts, and is retractable with respect to the third fixed portion 43a to stop compression.

Specifically, the third piston 43 comprises six third movable portions 43b arranged with respect to each other in much the same way as the six fourth dispensing cylinders 26 and each associated with a respective fourth chamber 41.

In detail, the six third movable portions 43b are arranged around the third fixed portion 43a, surrounding it along its perimeter.

The six third movable portions 43b are extendable and retractable with respect to the third fixed portion 43a simultaneously.

By doing so, in fact, it is possible to dispense from each of the six fourth dispensing cylinders 26 at least part of the cold cuts contained therein and to distribute it, in this way, evenly on the pizza disc D.

Again, each third movable portion 43b is provided with at least a third enlarged end 43c sized so as to slide to fit a respective fourth chamber 41.

As a result of the movement of the third enlarged ends 43c, therefore, enough compressive force can be exerted on the cold cuts contained in the fourth chambers 41 to push them downwards and, in particular, towards the slicing body 42.

In this way, it is clearly possible to slice the cold cuts forced against the slicing ports 42a and thus dispense the resulting slices of cold cuts outwards onto the pizza disc.

It should be specified, however, that alternative embodiments cannot be ruled out wherein the sets of fourth dispensing cylinders 26 comprise a different number of fourth dispensing cylinders 26, e.g., an individual fourth dispensing cylinder 26.

In this case, the third piston 43 comprises an individual third movable portion 43b provided with an individual third enlarged end 43c sliding to size in the only fourth chamber 41.

Having finished the description of the topping system 22, it should be added that the machine 1 comprises, in addition, at least one baking area, not shown in the drawings for simplicity sake, which is operatively connected to the topping area C and comprises at least one device for baking the topped pizza disc D which is adapted to obtain a baked pizza.

Thus, the topped pizza disc D is sent from the topping area C to the baking area and, once it arrives there, it is baked inside the baking device, e.g., for a time corresponding to at least a predetermined baking time.

The baking device can be of the type of an oven, e.g. an electric oven that can be automatically activated as a result of the arrival of the topped pizza disc D in the baking area.

Finally, the machine 1 comprises a baked pizza packing area that is operatively connected to the baking area and has at least one container which can be filled with pizza.

Conveniently, the packing area is made communicating with the outside.

In this way, once placed inside the container, the pizza can be delivered directly outside the machine 1 and can thus be picked up by the user and consumed.

It has in practice been ascertained that the described invention achieves the intended objects.

In particular, the fact is emphasized that the special expedient of arranging the dispensing cylinders parallel to each other around a vertical central axis makes it possible to greatly reduce the overall dimensions compared with the prior art mentioned above.

In addition, the special expedient of providing a selector disc located between the positioning means and the dispensing cylinders makes it possible to minimize the risk of some ingredients intended to be distributed on the pizza disc unintentionally dropping onto the components of the machine below.

The fact of providing positioning means of the transport element under each dispensing cylinder allows, then, for effective and precise topping of the pizza discs.

The fact is also emphasized that the special expedient of providing a movement system and a topping system makes it possible to obtain a compact and easily transportable automatic pizza preparation machine which allows automatic pizzas to be prepared in a short time, at any time of the day, and from freshly stored ingredients.

Finally, the special expedient of arranging the pizza discs contained in a respective storage tank within an individual containment package makes it possible to obtain an automatic pizza preparation machine with low environmental impact.

1) Topping system (22) of pizza discs for automatic pizza preparation machines, comprising a plurality of dispensing cylinders (23, 24, 25, 26), each containing at least one ingredient which is usable as a topping for at least one pizza disc (D) and is deliverable by dropping onto the latter, characterized by the fact that it comprises positioning means (27) which are arranged inferiorly to said dispensing cylinders (23, 24, 25, 26) and are adapted to position said pizza disc (D) at least at the point where each of said dispensing cylinders (23, 24, 25, 26) is located, said dispensing cylinders (23, 24, 25, 26) being arranged parallel to each other around at least one substantially vertical common central axis (A).

2) System (22) according to claim 1, characterized by the fact that said positioning means (27) comprise:
at least one pair of movable rods (27a) lying in a substantially horizontal lying plane and arranged substantially orthogonal to each other, said movable rods (27a) being movable along substantially horizontal mutual directions and orthogonal to each other;
at least one coupling element (27b) which is mounted on said movable rods (27a) in a sliding manner and is coupleable to at least one transport element (12) on which at least one pizza disc (D) is positioned.

3) System (22) according to claim 1, characterized by the fact that it comprises at least one selector disc (29) which is rotatable around said central axis (A) and is positioned between said positioning means (27) and said dispensing cylinders (23, 24, 25, 26), said selector disc (29) being provided with at least one selector hole (29a) selectively alignable with each of said dispensing cylinders (23, 24, 25, 26) and traversable by said ingredients delivered on said pizza disc (D).

4) System (22) according to claim 1, characterized by the fact that said dispensing cylinders (23, 24, 25, 26) comprise at least a first dispensing cylinder (23) comprising:
at least one first chamber (30) containing a topping in the form of a tomato sauce gel; and
first delivery means (31, 32, 33) associated with said first chamber (30) which are adapted to deliver at least part of said tomato sauce onto said pizza disc (D).

5) System (22) according to claim 4, characterized by the fact that said first delivery means (31, 32, 33) comprise:
at least one outlet die (31) associated inferiorly with said first chamber (30) which is adapted to extrude said tomato sauce and is provided with a plurality of outlet holes (32) traversable by said extruded tomato sauce for the delivery thereof outwardly; and
at least one first piston (33) arranged superiorly to said outlet die (31) and extendable to compress said tomato sauce against said outlet die (31), forcing it through said outlet holes (32).

6) System (22) according to claim 5, characterized by the fact that said outlet die (31) comprises at least one first outlet die (31a) and at least one second outlet die (31b) which are provided with a plurality of first outlet holes (32a) and of second outlet holes (32b) respectively, traversable by said tomato sauce and mutually rotatable with respect to a substantially vertical axis between at least one opening position, wherein said first outlet holes (32a) and said second outlet holes (32b) are aligned, and at least one closing position, wherein said first outlet holes (32a) and said second outlet holes (32b) are misaligned.

7) System (22) according to claim 1, characterized by the fact that said dispensing cylinders (23, 24, 25, 26) comprise at least a second dispensing cylinder (24) comprising:
at least one second chamber (34) containing at least one pasta filata cheese; and
second delivery means (35, 36, 37) associated with said second chamber (34) which are adapted to deliver at least part of said pasta filata cheese onto said pizza disc (D).

8) System (22) according to claim 7, characterized by the fact that said second delivery means (35, 36, 37) comprise:
at least one grater body (35) associated inferiorly with said second chamber (34) which is adapted to obtain a plurality of shreds of pasta filata cheese and is provided with a plurality of cutting slots (36) traversable by said shreds for the delivery of said shreds outwardly; and
at least one second piston (37) arranged superiorly to said grater body (35) and extendable to compress said pasta filata cheese against said grater body (35), forcing it through said cutting slots (36).

9) System (22) according to claim 1, characterized by the fact that said dispensing cylinders (23, 24, 25, 26) comprise at least a third dispensing cylinder (25) comprising:
at least a third chamber (38) containing vegetables; and
third delivery means (39, 40) associated with said third chamber (38) which are adapted to deliver at least part of said vegetables on said pizza disc (D).

10) System (22) according to claim 9, characterized by the fact that said third delivery means (39, 40) comprise at least one portioning chamber (39) which is associated inferiorly with said third chamber (38) and is communicating with the latter, said portioning chamber (39) being fillable with said vegetables and being provided with at least one lower opening (39a) for the delivery of said vegetables outwardly.

11) System (22) according to claim 10, characterized by the fact that said third delivery means (39, 40) comprise at least one auger device (40) arranged inside said third chamber (38) and operable in rotation to transfer at least part of said vegetables from said third chamber (38) to said portioning chamber (39).

12) Pizza-making machine (1), characterized by the fact that it comprises:
at least one topping system (22) according to claim 1;
at least one movement system (5) of said pizza discs (D) comprising:
at least one base frame (6) defining at least one storage area (S) of said pizza discs (D);
at least one topping area (C) of said pizza discs wherein said topping system (22) is located;
at least one storage tank (9) located in said storage area (S) which is provided with at least one outlet port (9a) of said pizza discs (D) and defines at least one containment volume (9b) of said pizza discs (D) inside it;
at least one transport assembly (12) which is adapted to transport said pizza disc (D) from said storage area (S) towards said topping area (C) and comprises said transport element (12).
at least one extraction and transfer assembly (13, 14, 18) which is adapted to individually extract said pizza disc (D) from said containment volume (9b) and to transfer it onto said transport element (12).

13) Machine (1) according to claim 12, characterized by the fact that said extraction and transfer assembly (13, 14, 18) comprises extraction and transfer means (13) associated with said base frame (6) and comprising at least one gripping device (13a) arranged superiorly to said storage tank (9) configured to retain said pizza disc (D) and to release said pizza disc (D).

14) Machine (1) according to claim 13, characterized by the fact that said extraction and transfer means (13) comprise activation means (13c) associated with said gripping device (13a) and adapted to enable the activation and deactivation of the latter depending on the gripping and the release of said pizza disc (D), respectively.

15) Machine (1) according to claim 14, characterized by the fact that said gripping device (13a) comprises at least one suction cup element (13b) which is intended to abut against said pizza disc (D).

16) Machine (1) according to claim 15, characterized by the fact that said extraction and transfer means (13) comprise adjustment means (13d) of the height of said suction cup element (13b) with which the latter is associated by integral shift, said adjustment means (13d) being vertically movable between at least one lowered position, wherein said suction cup element (13b) is arranged in said storage area (S), and at least one raised position, wherein said suction cup element (13b) is arranged in said topping area (C).
